(19) United States
(12) Patent Application Publication
(10) Pub. No.: US 2007/0041353 A1
(43) Pub. Date: Feb. 22, 2007

(54) Time Management in a Wireless Access Point

(75) Inventors: Yangyang Li, Hamilton, ON (CA); Terence Douglas Todd, Hamilton, ON (CA); Dongmei Zhao, Hamilton, ON (CA)

Correspondence Address: INTEGRAL INTELLECTUAL PROPERTY INC., 44 LONGWOOD DRIVE, TORONTO, ON, M3B 1T8, CA

(73) Assignee: MCMASTER UNIVERSITY, Hamilton (CA)

(21) Appl. No.: 11/464,535

(22) Filed: Aug. 15, 2006

Related U.S. Application Data
(60) Provisional application No. 60/709,105, filed on Aug. 18, 2005.

(51) Int. Cl. H04Q 7/24

(52) U.S. Cl. 370/338; 370/401

(57) ABSTRACT

Indications of one or more future unavailability time intervals are transmitted in a management frame by an access point to one or more wireless client devices associated therewith. During the unavailability time intervals, the access point is not available to receive unsolicited communication from the wireless client devices.

### CROSS-REFERENCE TO RELATED APPLICATIONS

This application claims priority under 35 USC 119(e) from U.S. Provisional Patent Application No. 60/709,105, filed Aug. 18, 2005, and which is incorporated by reference herein.

### BACKGROUND

The invention generally relates to wireless local area networks (WLAN). In particular, embodiments of the invention relate to time management and power saving for one or more access points (AP) in a wireless network.

In a basic service set (BSS), client devices may communicate with the access point over a common wireless communication channel using a time sharing scheme. Wireless access points of different BSSs may be connected via a distribution system (DS) that is usually a wired network.

With some network architectures, more than one access point may form the infrastructure of a BSS. For example, in a wireless mesh network, access points communicate with wireless client devices associated therewith and relay data to and from other access points in the wireless mesh network. The access points of the wireless mesh network may have a combined coverage area that is larger than the coverage area provided a single access point.

Different types of power sources may be used to power an access point. For example, an access point may be powered from an alternating current (AC) power source, a direct current (DC) power source, a wind-energy-conversion power source, a solar-energy-conversion power source, or any other suitable power source. Some access points may utilize charge storage components such as capacitors or rechargeable batteries to store electrical charge received from the power source.

### BRIEF DESCRIPTION OF THE DRAWINGS

Embodiments are illustrated by way of example and not limitation in the figures of the accompanying drawings, in which like reference numerals indicate corresponding, analogous or similar elements, and in which:

FIG. 1 is an illustration of an exemplary communications system including a wireless access point and two wireless client devices, according to some embodiments;

FIGS. 2, 3 and 4 are exemplary simplified timing diagrams of events in a wireless BSS, helpful in understanding some embodiments;

FIG. 5 is an illustration of an exemplary communications system including two wireless access points and two wireless client devices, according to some embodiments;

FIG. 6 is a simplified block diagram of an exemplary access point, according to some embodiments;

FIG. 7 is a flowchart of an exemplary method in an access point, according to an embodiment;

FIG. 8 is a simplified block diagram of an exemplary wireless client device, according to some embodiments;

FIG. 9 is a flowchart of an exemplary method in a wireless client device, according to an embodiment;

FIG. 10 is an exemplary simplified timing diagram of events in a wireless BSS, helpful in understanding some embodiments;

FIG. 11 is a graph of mean mobile station packet delay, according to some embodiments; and

FIG. 12 is a graph of AP mean power consumption, according to some embodiments.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

In the following detailed description, numerous specific details are set forth in order to provide a thorough understanding of embodiments. However it will be understood by those of ordinary skill in the art that the embodiments may be practiced without these specific details. In other instances, well-known methods, procedures, components and circuits have not been described in detail so as not to obscure the embodiments.

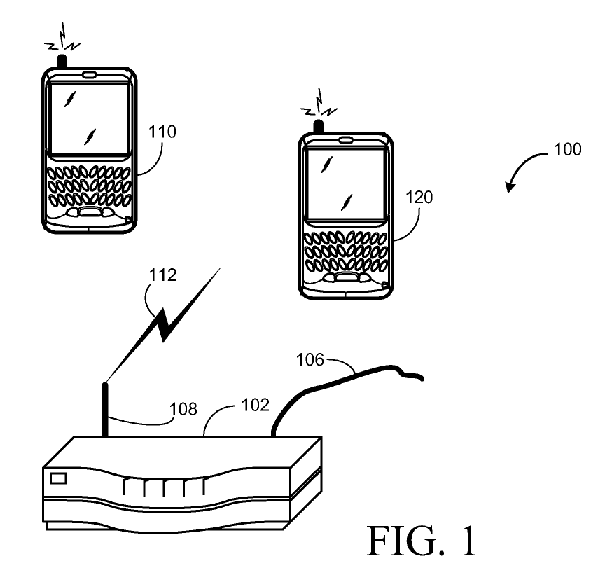

FIG. 1 is an illustration of an exemplary communications system 100 according to some embodiments. System 100 includes a wireless access point (AP) 102 coupled to a distribution system (DS) via a wired connection 106. AP 102 has at least one antenna 108. A non-exhaustive list of examples for antenna 108 includes a dipole antenna, a monopole antenna, a multilayer ceramic antenna, a planar inverted-F antenna, a loop antenna, a shot antenna, a dual antenna, an omnidirectional antenna and any other suitable antenna.

Exemplary communications system 100 includes wireless client devices 110 and 120. A non-exhaustive list of examples for any of client devices 110 and 120 includes a wireless-enabled laptop, a wireless-enabled cellphone, a wireless-enabled personal digital assistant (PDA), a wireless-enabled video camera, a wireless-enabled gaming console, a wireless Internet-Protocol (IP) phone and any other suitable wireless client device. Client devices 110 and 120 are able to execute processes to associate themselves with AP 102 in a wireless network. For example, client device 110 and/or client device 120 may become associated with AP 102 over a wireless medium 112.

In the example of FIG. 1, AP 102, client devices 110 and client device 120 are “802.11-enabled”, which means that wireless communications therebetween are in accordance with one or more of the IEEE 802.11 standards defined by the Institute of Electrical and Electronic Engineers (IEEE) for Wireless Local Area Network (LAN) Medium Access Control (MAC) and Physical layer (PHY) specifications.

The IEEE 802.11 standard explains that access points transmit a type of management frames denoted “beacon” frames at substantially regular time periods to announce the existence of and to synchronize wireless networks. The format of beacon frames and their contents is explained in detail in the IEEE 802.11 standard. The beacon interval is included in each beacon frame. The number of time units between target beacon transmission times is referred to as a “beacon interval”.

Each beacon frame also includes a timestamp which is the value of a clock internal to the access point at the actual transmission time of the beacon. Due to use of carrier sense multiple access (CSMA) techniques, the actual transmission time may be later than the target beacon transmission time. Consequently, the timestamp field of the beacon frame is not filled until the actual transmission occurs. A client device receiving the beacon frame will update its internal clock according to the timestamp in the received beacon frame.

Beacon frames optionally include a Traffic Indication Map (TIM) that identifies client devices for which unicast traffic is pending and buffered in the access point. This information is encoded in a partial virtual bitmap. The TIM also includes an indication whether broadcast or multicast traffic is pending.

There are two different TIM types: TIM and Delivery TIM (DTIM). A TIM includes a “DTIM count” field that indicates how many beacon frames (including the current frame) appear before the next DTIM. A DTIM count of zero indicates that the current TIM is a DTIM. The “DTIM period” field indicates the number of beacon intervals between successive DTIMs. Every DTIM period, a TIM of type “DTIM” is transmitted within a beacon, rather than an ordinary TIM. After a DTIM, the access point sends out the buffered broadcast or multicast traffic using normal frame transmission rules, before transmitting any unicast frames.

The IEEE 802.11 standard describes various mechanisms for communicating over a wireless medium, such as wireless medium 112, for example, DCF (Distributed Coordination Function), PCF (Point Coordination Function), and possibly other mechanisms.

With DCF, client devices that are part of a wireless network are permitted to initiate communication with the access point. In the example of FIG. 1, both client devices 110 and 120 are permitted to initiate communication with AP 102 using DCF. With DCF, there is a likelihood that client devices will try to initiate communication at substantially the same time, and that their transmitted signals will collide and interfere with each other. In order to minimize collisions over the wireless medium, Carrier Sense Multiple Access/Collision Avoidance (CSMA/CA) techniques are used with DCF for distributed arbitration of communication traffic.

With PCF, the AP coordinates communication over the wireless medium. Client devices are not permitted to initiate communication and can only respond to communication instructions received from the AP.

Time intervals in which PCF is in use are known as CFP (Contention Free Periods). During Contention Periods (CP), client devices transmit on the channel using DCF. As defined in the IEEE 802.11 standard, an AP can incorporate an optional set of parameters, denoted “CF parameter set”, in beacon frames, to notify client devices about CFP periods. CFP periods must start after DTIMs, and the AP can define CFP periods to periodically start at a whole number of DTIM intervals. The length of CFP periods is defined in the CF parameter set in TU (Time Units) of 1024 uS.

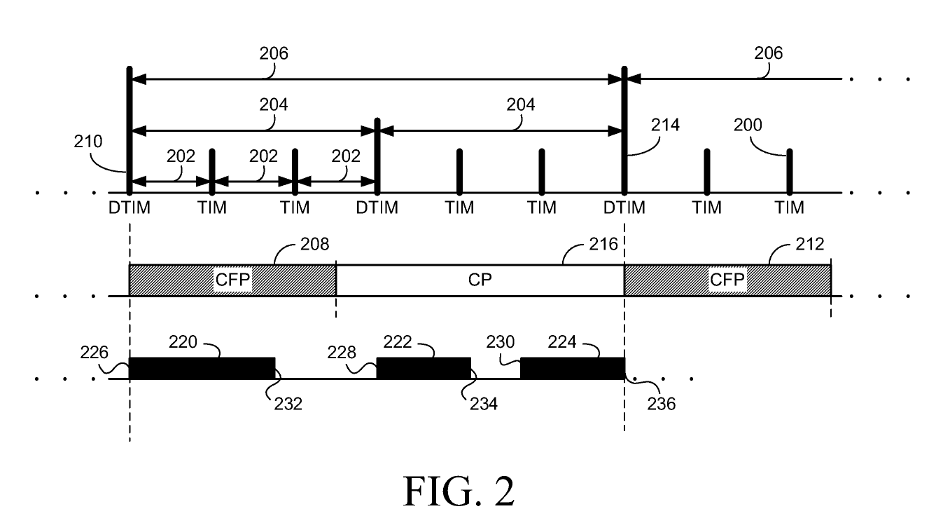

By way of example, and not limitation, FIG. 2 shows an exemplary simplified timing diagram of events in a wireless BSS, helpful in understanding some embodiments.

AP 102 transmits beacon frames 200 spaced with substantially equal beacon intervals 202. All beacon frames 200 contain a TIM, and once per a DTIM interval 204 that in this example equals three beacon intervals 202, beacon frames include a DTIM. CFP periods are configured to start substantially periodically, spaced by a contention-free interval 206 that in this example equals two DTIM intervals 204. In the example of FIG. 2, a CFP period 208 starts after a beacon frame 210 that contains a DTIM, and a CFP period 212 starts after a beacon frame 214 that contains a DTIM. As a default, an intervening time interval 216 is a CP period. A “contention-free interval” begins at the start of a “superframe”.

The IEEE 802.11 standard assumes that an AP is always able to accept communication from client devices in its wireless network. According to some embodiments, in order to conserve power, or for any other reason, an AP may be able to notify client devices in its network that at future, non-overlapping time intervals the AP will not be available to receive unsolicited communication from the client devices.

In the example of FIG. 2, AP 102 notifies client devices 110 and 120 that during the “superframe” starting after beacon frame 210, AP 102 will not be available to receive unsolicited communication during unavailability intervals 220, 222 and 224. AP 102 may notify client devices 110 and 120 when to expect the beginnings 226, 228 and 230 and the ends 232, 234 and 236 of unavailability intervals 220, 222 and 224, respectively.

AP 102 may notify client devices 110 and 120 about unavailability intervals by transmitting a corresponding parameter set. By way of example, and not limitation, such a parameter set is denoted hereinbelow as a Network Allocation Map (NAM). The NAM may be transmitted using unicast transmissions directed to the client devices, or using multicast or broadcast transmissions. A NAM may be incorporated in management frames (including, for example, management frames that are not beacon frames) as a modification of existing parameters or as new, additional parameters.

By way of example, and not limitation, in the example of FIG. 2, a NAM may be broadcasted as part of a beacon frame that is the start of a superframe, e.g. beacon frames 210 and 214.

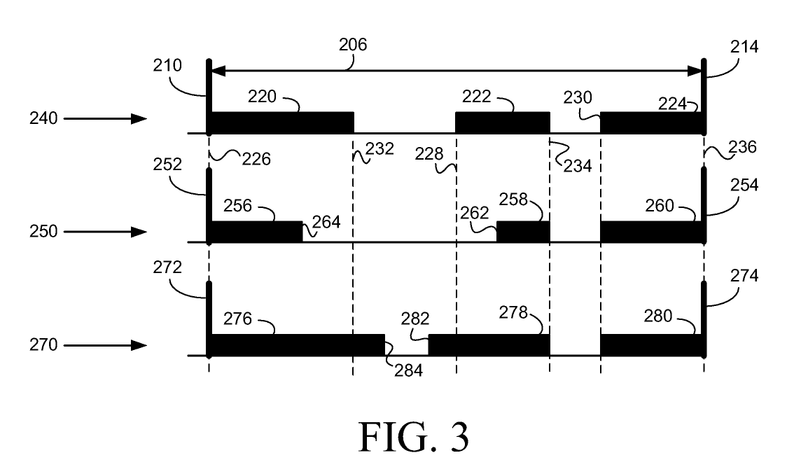

FIG. 3 shows another exemplary simplified timing diagram of events in a wireless BSS, helpful in understanding some embodiments. In the example of FIG. 3, superframes are configured to recur substantially periodically with contention-free intervals 206. Line 240 shows the superframe starting at beacon frame 210 and ending before beacon frame 214, together with the corresponding unavailability intervals 220, 222 and 224. Line 250 shows a second superframe starting at a beacon frame 252 and ending before a beacon frame 254, together with three corresponding unavailability intervals 256, 258 and 260. Line 270 shows a third superframe starting at a beacon frame 272 and ending before a beacon frame 274, together with three corresponding unavailability intervals 276, 278 and 280.

According to some embodiments, in addition to providing client devices 110 and 120 with indications of unavailability intervals in a coming superframe, AP 102 may define whether particular beginnings and ends of the unavailability intervals are movable indications applicable to that single superframe or are fixed indications applicable to periodic recurrences of superframes.

For example, AP 102 may define that beginnings 226 and 230 and ends 234 and 236 are fixed indications to be repeated in recurring superframes. Therefore, unavailability intervals 220, 256 and 276 may begin with substantially equal delays from beacon frames 210, 252 and 272, respectively, and unavailability intervals 224, 260 and 280 may begin with substantially equal delay from beacon frames 210, 252 and 272, respectively. In addition, AP 102 may also define that ends 234 and 236 are fixed indications to be repeated in recurring superframes. Therefore, unavailability intervals 222, 258 and 278 may end with substantially equal delays from beacon frames 210, 252 and 272, respectively, and unavailability intervals 224, 260 and 280 may end with substantially equal delays from beacon frames 210, 252 and 272, respectively.

AP 102 may define that beginning 228 and end 232 are movable indications that are applicable to one or more superframes. Therefore, beginning 228, beginning 262 of unavailability interval 258 and beginning 282 of unavailability interval 278 may have different delays from beacon frames 210, 252 and 272, respectively. In addition, end 232, end 264 of unavailability interval 256 and end 284 of unavailability interval 276 may have different delays from beacon frames 210, 252 and 272, respectively.

Ends and/or beginnings of unavailability intervals, that are applicable to single superframes, may have different values assigned thereto by AP 102 in different superframes. AP 102 may consider, for example, a trade-off between power saving and communication bandwidth, when determining the values of movable indications of unavailability intervals. For example, unavailability intervals 276, 278 and 280 comprise a larger percentage of the superframe starting after beacon frame 272 than the percentage of the superframe starting after beacon frame 252 that is comprised by unavailability intervals 256, 258 and 260. As a result, AP 102 can potentially save more power but communicate less traffic during the superframe starting after beacon frame 272 than during the superframe starting after beacon frame 252.

Communication bandwidth and power saving may be determined and changed by adjusting beginning and ends of unavailability intervals dynamically, e.g. every one or more superframes, or quasi-statically at much longer time intervals.

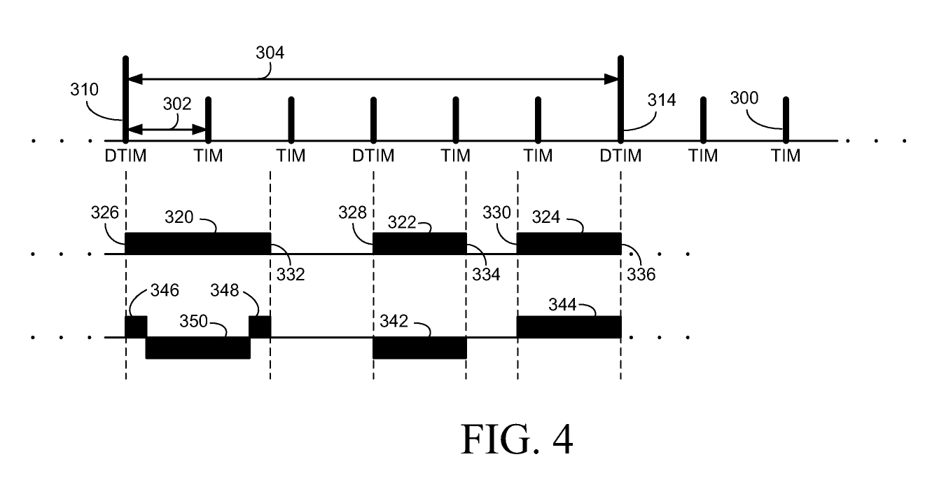

FIG. 4 shows another exemplary simplified timing diagram of events in a wireless BSS, helpful in understanding some embodiments. The timing diagram shown in FIG. 4 does not include any CFP periods, and therefore represents a more common situation than the timing diagram shown in FIG. 2. AP 102 transmits beacon frames 300 spaced with substantially equal beacon intervals 302. All beacon frames 300 contain a TIM, and once per a DTIM interval 304 that in this example equals six beacon intervals 302, beacon frames include a DTIM.

In the example of FIG. 4, AP 102 notifies client devices 110 and 120 that after a beacon frame 310 that includes a DTIM, AP 102 will not be available to receive unsolicited communication during unavailability intervals 320, 322 and 324. AP 102 may notify client device 110 and 120 when to expect the beginnings 326, 328 and 330 and the ends 332, 334 and 336 of unavailability intervals 320, 322 and 324, respectively.

By way of example, and not limitation, in the example of FIG. 4, a NAM may be broadcasted as part of beacon frames 300 that contain a DTIM, e.g. beacon frames 310 and 314.

FIG. 2 demonstrates unavailability intervals that are referenced in time to superframes and FIG. 4 demonstrates unavailability intervals that are referenced in time to beacon frames that contain a DTIM. Nevertheless, according to some embodiments, unavailability intervals may be timed relative to any other events in a BSS.

For example, the draft amendment D7 for proposed IEEE 802.11e includes an additional coordination function called HCF (Hybrid Coordination Function) that is useable for QoS network (QESS) configurations and is proposed to be implemented in all wireless stations that support QoS (Denoted QSTA). The HCF combines functions from the DCF and PCF with some enhancements, QoS-specific mechanisms and frame sub-types to allow a uniform set of frame exchange sequences to be used for QoS data transfers during both CP periods and CFP periods. The HCF uses both a contention-based channel access mechanism, called EDCA (Enhanced Distributed Channel Access), for contention-based transfers, and a controlled channel access mechanism, referred to as HCCA (HCF Controlled Channel Access), for contention-free transfers.

For simplicity of the explanation, embodiments in an environment including EDCA and HCCA are not described here in detail, however, it should be clear to a person of ordinary skill in the art how to modify the embodiments that are described to suit such an environment.

AP 102 may decrease its power consumption by controlling its circuitry to be in a power-saving state during a part of the one or more unavailability time intervals. Similarly, AP 102 may communicate data on behalf of wireless client devices associated therewith during at least a part of the one or more unavailability time intervals, as described hereinbelow.

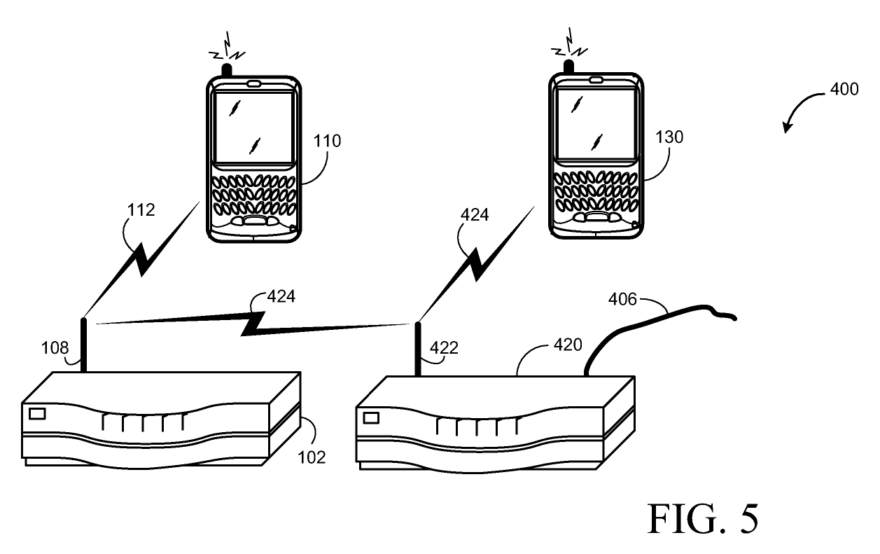

FIG. 5 is an illustration of an exemplary communications system 400 according to some embodiments. System 400 includes AP 102, and an 802.11-enabled AP 420 that is coupled to a DS via a wired connection 406. AP 420 has at least one antenna 422. A non-exhaustive list of examples for antenna 422 includes a dipole antenna, a monopole antenna, a multilayer ceramic antenna, a planar inverted-F antenna, a loop antenna, a shot antenna, a dual antenna, an omnidirectional antenna and any other suitable antenna.

Exemplary communications system 400 includes wireless client device 110 and a wireless client device 130 that are 802.11-enabled. Client devices 110 and 130 are able to execute processes to associate themselves with AP 102 or AP 420 in a wireless network.

AP 102 and 420 may be part of a wireless mesh network, where AP 420 provides wired connectivity to the distribution system, and AP 102 and optional additional APs (not shown) use wireless connections in order to effectively increase the coverage area to client devices beyond the actual coverage area provided by AP 420. Client device 130 is in the coverage area of AP 420 and is associated with AP 420 over a wireless medium 424. Client device 110 is in the coverage area of AP 102 and is associated with AP 102 over a wireless medium 112. In addition, AP 102 is able to communicate with AP 420 over wireless medium 424 on behalf of client device 110 and any other wireless client devices associated with AP 102.

In the timing example of FIG. 4, during the entire unavailability interval 324, AP 102 may decrease its power consumption by controlling its circuitry to be in a power-saving state. This power-saving time is illustrated by time interval 344 that equals unavailability interval 324.

In another example, during unavailability interval 322, AP 102 may attempt to communicate with AP 420 over wireless medium 424 on behalf of client device 110 and any other wireless client devices associated with AP 102. This time is demonstrated by time interval 342 that equals unavailability interval 322. During time interval 342, AP 102 may relay data previously received from client device 110 to AP 420, and/or may receive data from AP 420 to forward to client device 110.

In another example, unavailability interval 320 may be divided into three subintervals 346, 348 and 350. During time intervals 346 and 348, AP 102 may decrease its power consumption by controlling its circuitry to be in a power-saving state. During time interval 350, AP 102 may communicate with AP 420 over wireless medium 424 on behalf of client device 110.

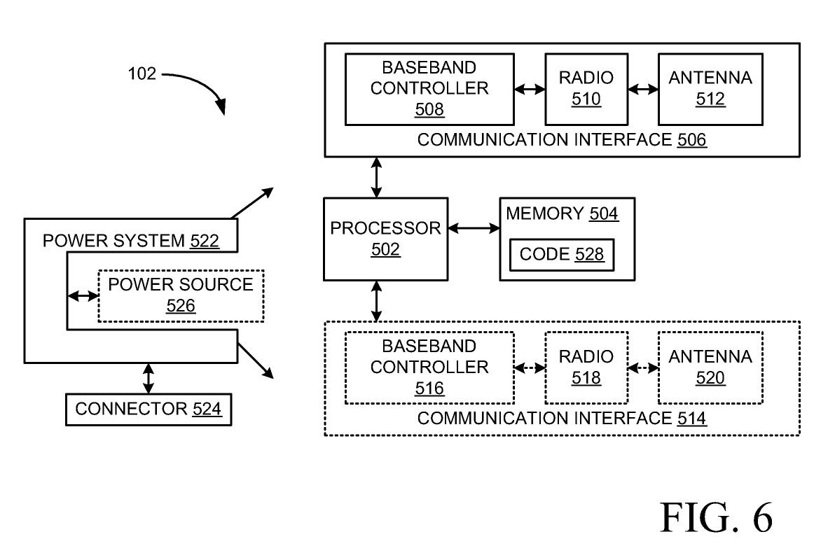

FIG. 6 is a simplified block diagram of exemplary AP 102, according to some embodiments. AP 102 includes a processor 502 and a memory 504 coupled to processor 502. Memory 504 includes code 528 that is described hereinbelow.

AP 102 includes a wireless communication interface 506, compatible with one or more standards of the family of IEEE 802.11 wireless communication standards. Wireless communication interface 506 is coupled to processor 502 and includes at least a baseband controller 508, a radio 510, and an antenna 512. AP 102 may optionally include an additional wireless communication interface 514, compatible with one or more standards of the family of 802.11 wireless communication standards. Wireless communication interface 514 is coupled to processor 502 and includes at least a baseband controller 516, a radio 518, and an antenna 520.

By way of wireless communication interface 506 and/or wireless communication interface 514, AP 102 may be able to establish communication sessions with other devices, such as client devices 110 and 120 and AP 420.

AP 102 includes a power system 522 and a connector 524 coupled to power system 522. AP 102 may optionally include a power source 526 coupled to power system 522. Connector 524 is connectable to an external power source (not shown) to provide power for charging power source 526 and/or for operating AP 102. Power system 522 provides electrical coupling between the external power source and power source 526, and provides electrical coupling between power source 526 and the electrical components of AP 102 (e.g. processor 502, memory 504, and the like). As part of the electrical coupling between the external power source and power source 526, power system 522 may control the charging of power source 526 with electrical charge drawn from the external power source.

A non-exhaustive list of examples for power source 526 includes one or more Ni—Cd (Nickel Cadmium) batteries, one or more Ni-MH (Nickel-Metal Hydride) batteries, one or more Lithium Ion batteries, one or more rechargeable Alkaline batteries, one or more capacitors, one or more super-capacitors, and any other suitable power source. A non-exhaustive list of examples for an external power source includes an AC power source, a DC power source, wind-power-conversion power source, solar-power-conversion power source.

Processor 502, memory 504, one or more of baseband controllers 508 and 516, and one or more of radios 510 and 518 are examples of circuitry that can be controlled to be in power-saving states during at least a part of the one or more unavailability time intervals.

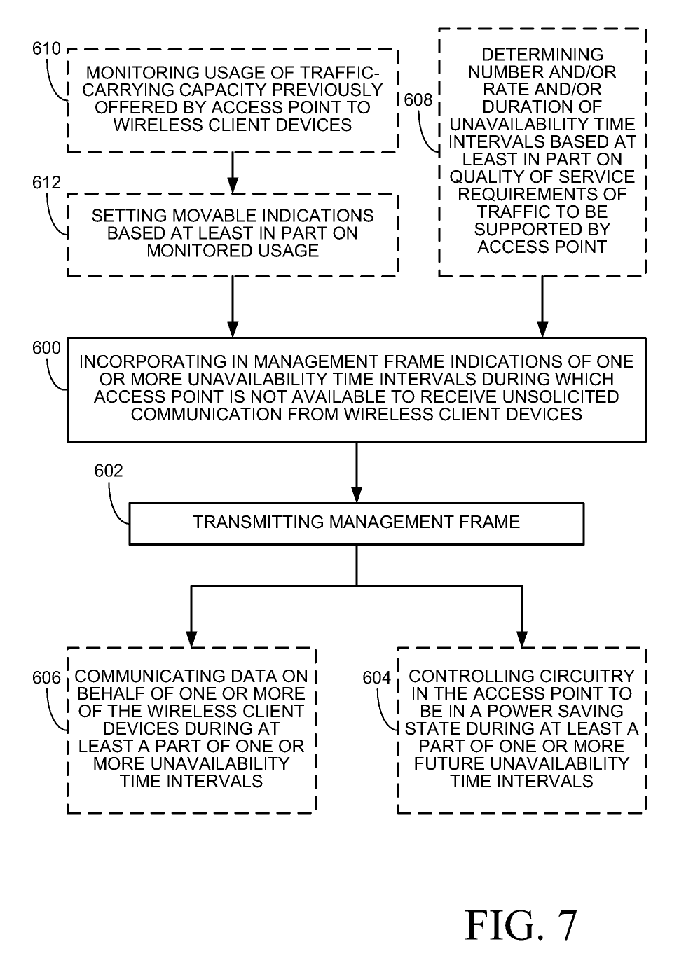

Reference is made now to FIG. 7, which is a flowchart of an exemplary method in AP 102, according to an embodiment. Code 528, when executed by processor 502 may cause AP 102 to perform the method of FIG. 7.

At 600, AP 102 may incorporate in a management frame indications of one or more future unavailability time intervals in which AP 102 is not available to receive unsolicited communication from wireless client devices such as client devices 110 and 120. Such future unavailability time intervals may overlap, at least in part, any CP periods, CFP periods, EDCA periods, HCCA periods, or any other communication periods as desired.

The indications transmitted in the management frame may indicate beginning times and end times of the unavailability time intervals with reference to an event of the wireless network, for example, the beginning of a contention-free interval or the end of transmission of a beacon frame that contains a Delivery Traffic Indication Map. Alternatively, the indications may indicate beginning times and durations of the unavailability time intervals, the beginning times being defined with reference to an event of the wireless network. Alternatively, the indications may indicate end times and durations of the unavailability time intervals, the end times being defined with reference to an event of the wireless network.

At 602, AP 102 may transmit the management frame.

During any desired part of any of the unavailability time intervals, AP 102 may control circuitry in AP 102 to be in a power-saving state, as at 604, or may communicate data on behalf of one or more of the wireless client devices associated therewith, as at 606.

Prior to incorporating the indications in the management frame, AP 102 may determine at 608 one or more of the number, rate and duration of the unavailability time intervals based at least in part on quality of service (QoS) requirements of traffic to be supported by AP 102. For example, these requirements may include advanced power save delivery (APSD) or modified versions thereof.

Moreover, prior to incorporating the indications in the management frame, AP 102 may monitor at 610 usage of traffic-carrying capacity previously offered by AP 102 to wireless client devices associated therewith. AP 102 may set at 612 the movable indications based at least in part on the monitored usage to decrease, maintain or increase traffic-carrying capacity offered by AP 102 in a period of time that includes the one or more unavailability time intervals defined by the indications.

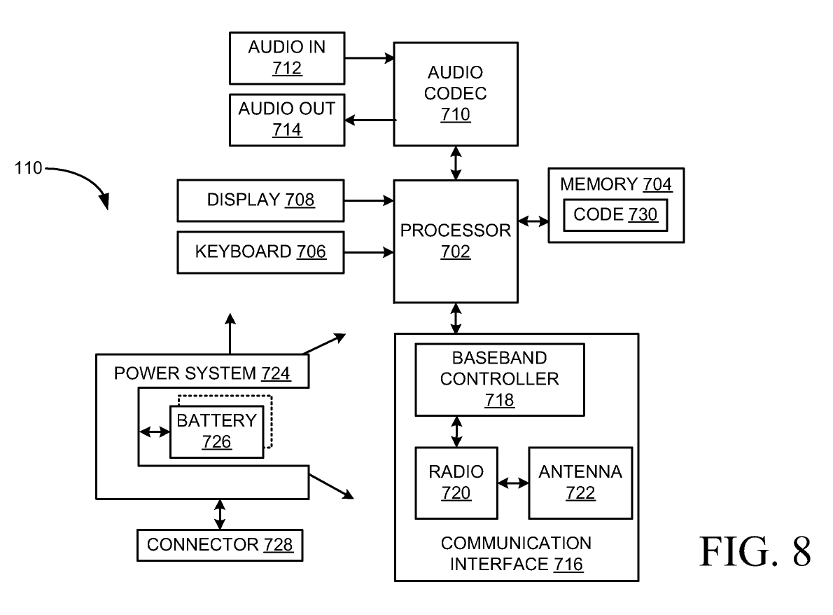

FIG. 8 is a simplified block diagram of exemplary wireless client device 110, according to some embodiments. Device 110 includes a processor 702, a memory 704, a keyboard 706, a display 708, audio coder-decoder (codec) 710, an audio input device 712, and an audio output device 714. Memory 704, keyboard 706, display 708 and audio codec 710 are coupled to processor 702. Memory 704 includes code 730.

Device 110 includes a wireless communication interface 716, compatible with one or more standards of the family of IEEE 802.11 wireless communication standards. Wireless communication interface 716 is coupled to processor 702 and includes at least a baseband controller 718, a radio 720, and an antenna 722. By way of wireless communication interface 716, device 110 may be able to establish communication sessions with other devices, such as AP 102 and AP 420.

A non-exhaustive list of examples for communication sessions includes telephone communication sessions, sending and receiving electronic mail (Email), sending and receiving instant messages, sending and receiving paging messages, sending and receiving short message service (SMS) messages, and any other suitable communication sessions.

Device 110 includes a power system 724, one or more batteries 726 coupled to power system 724, and a connector 728 coupled to power system 724. Connector 728 is connectible to an external power source (not shown) to provide power for charging batteries 726 and/or for operating device 110. Power system 724 provides electrical coupling between the external power source and batteries 726, and provides electrical coupling between batteries 726 and the electrical components of device 110 (e.g. processor 702, memory 704, and the like). As part of the electrical coupling between the external power source and batteries 726, power system 724 may control the charging of batteries 726 with electrical charge drawn from the external power source.

A non-exhaustive list of examples for batteries 726 includes Ni—Cd batteries, Ni-MH batteries, Lithium Ion batteries, rechargeable Alkaline batteries, and any other suitable batteries.

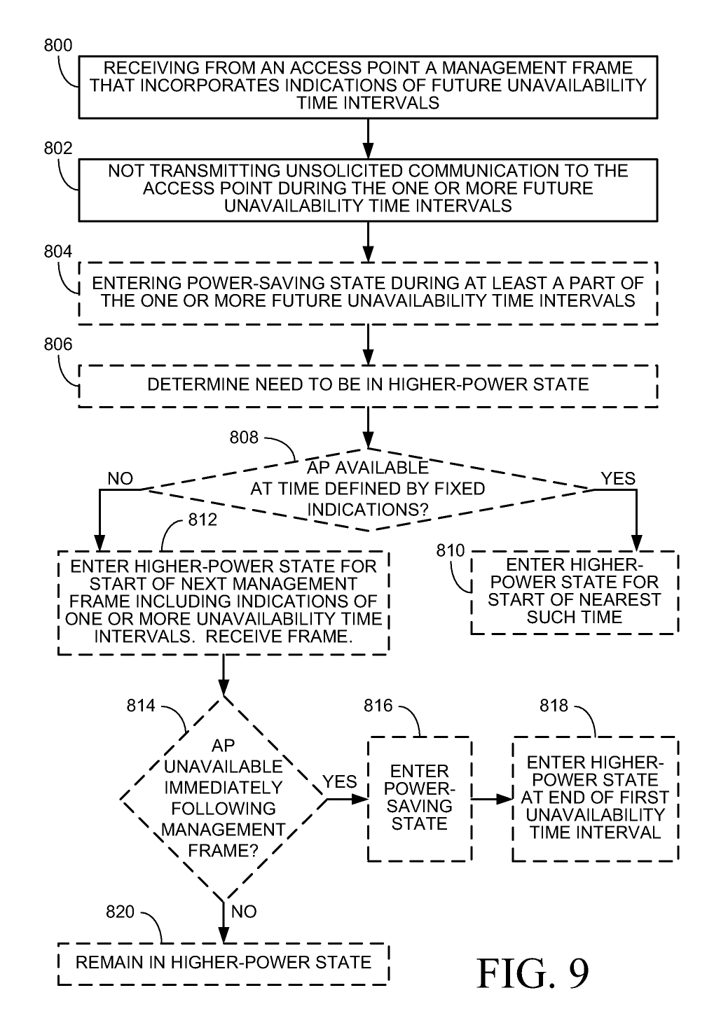

Reference is made now to FIG. 9, which is a flowchart of an exemplary method in wireless client device 110, according to an embodiment. Code 730, when executed by processor 702 may cause client device 110 to perform the method of FIG. 9.

At 800, client device 110 may receive a management frame from AP 102, that incorporates indications of one or more future unavailability time intervals during which AP 102 will not be available to receive unsolicited communication from client device 110. Consequently, client device 110 will not transmit unsolicited communication to AP 102 during the future unavailability time intervals, as at 802. In addition, optionally, client device 110 may enter a power-saving state during at least one of the unavailability time intervals, as at 804. AP 102 may be notified by client device 110 of the entry into the power-saving state using standard IEEE 802.11 procedures.

Processor 702, memory 704, baseband controller 718 and radio 720 are examples of circuitry that can be controlled to be in power-saving states during unavailability time intervals.

A client device may choose to enter a power-saving state for periods of time that include multiple recurrences of the event with reference to which the indications of the future unavailability time intervals are defined. Upon exiting the power-saving state, the client device may not be aware of the unavailability time intervals currently defined for the AP with which it is associated.

For example, client device 110 may enter a power-saving state for several superframes, and when client device 110 returns to a higher-power state, it may not be aware of the unavailability time intervals that were defined by AP 102 for the current superframe.

As explained hereinabove, fixed indications are applicable with reference to recurrences of the event, but movable indications are applicable only with reference to a single occurrence of the event. Therefore, if the indications of one or more unavailability time intervals in the management frame received by client device 110 at 800 are such that a time during which AP 102 is available to receive unsolicited communication from client devices is bounded by fixed indications, then client device 110 can be certain that AP 102 will be available during a corresponding time following a recurrence of the event. However, if no such time bounded by fixed indications exists, client device 110 will need to listen to a subsequent management frame in order to be aware of any currently defined unavailability time intervals.

At 806, client device 110 may determine a need to exit the power-saving state and enter a higher-power state. For example, client device 110 may have generated one or more packets that need to be transmitted to AP 102.

If AP 102 will be available during a time that is bounded by fixed indications (checked at 808), then client device 110 may remain in the power-saving state until exiting the power-saving state in preparation for the start of the nearest such time, as at 810.

However, if no such time is defined (implicitly or otherwise) by the indications of the management frame received in 800, then in order to fulfill the need identified at 806, client device 110 may enter the higher-power state in preparation for the start of the next management frame that is to include indications of one or more unavailability time intervals and remain in the higher-power state to receive the frame, as at 812.

At 814, it is checked whether according to the indications received at 812 there is an unavailability time interval starting immediately following the transmission of the management frame. If so, then at 816, client device 110 may re-enter the power-saving state, and at 818, in order to fulfill the need determined at 806, client device 110 may enter the higher-power state at the end of that first unavailability time interval (whether that end is defined by a fixed indication or a movable indication). If not, then at 820, client device 110 may remain in a higher-power state in order to fulfill the need determined at 806.

Simulation Model

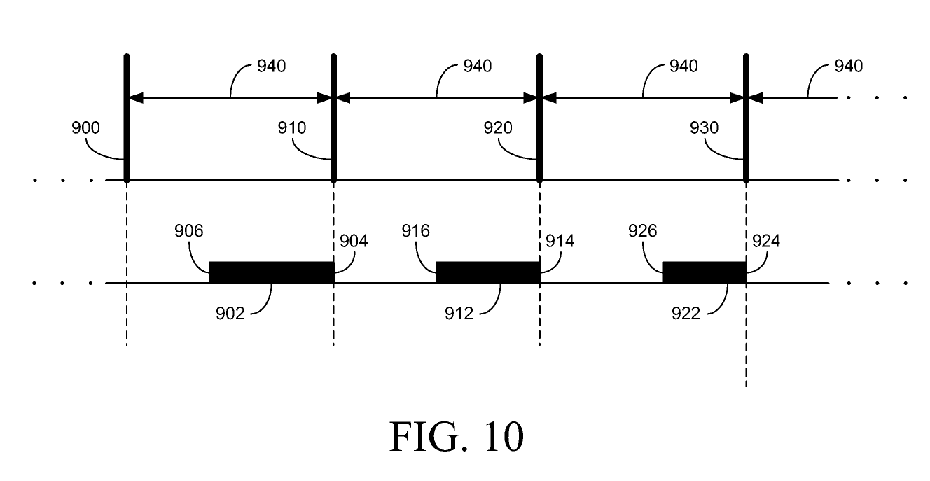

A particular scenario was analyzed and simulated to evaluate a particular algorithm for dynamically updating channel activities so that traffic load changes can be quickly accommodated. Reference is now made to FIG. 10, which is an exemplary simplified timing diagram of events in a wireless BSS, helpful in understanding some embodiments. In the scenario, an access point transmits beacon frames 900, 910, 920, 930 at a beacon interval 940. A superframe is a single beacon period. In beacon frame 900, the AP transmits indications of a single unavailability time interval 902 during which the AP is not available to receive unsolicited communication from wireless client devices that are associated with the AP. During the remainder of the superframe beginning with beacon frame 900, the AP is available to receive unsolicited communication from wireless client devices that are associated with the AP. The AP may use all or part of unavailability time interval 902 to control its circuitry into a power-saving state.

Similarly, in beacon frames 910 and 920, the AP transmits indications of an unavailability time interval 912 and 922, respectively, during which the AP is not available to receive unsolicited communication from wireless client devices that are associated with the AP.

Unavailability time intervals 902, 912 and 922 have respective ends 904, 914 and 924 that are represented by fixed indications. That is, these unavailability time intervals all end at the same time relative to the recurring wireless network event which is the reference for the end indication. In this case, the recurring wireless network event is the beacon transmission time.

Unavailability time intervals 902, 912 and 922 have respective beginnings 906, 916 and 926 that are represented by movable indications. That is, these unavailability time intervals begin at a time that is applicable to a single occurrence of the recurring wireless network event which is the reference for the beginning indication. In this case, the recurring wireless network event is the beacon transmission time.

In the example shown in FIG. 10, the unavailability time intervals are progressively shortened from one superframe to the next in order to increase the traffic-carrying capacity of the AP.

By measuring channel utilization during the portion of a superframe where the AP is available to carry traffic, the AP may adjust its availability in a subsequent superframe by appropriately setting the movable beginning of the unavailability time interval for that superframe. To model the evolution of the movable boundary between the availability interval and the unavailability interval as time progresses, the duration of the availability interval in the i^{th} superframe was denoted t_{AVAIL}(i), and the duration of the unavailability interval in the i^{th} superframe was denoted t_{UNAVAIL}(i). For simplicity, the duration of the entire superframe was normalized to 1, so that t_{AVAIL}(i)+t_{UNAVAIL}(i)=1.

For the i^{th} superframe, an error signal was defined to be the difference between the achieved usage of traffic-carrying capacity offered by the AP, denoted U(i), and a target usage based on a normalized utilization threshold, denoted U_{TH}. This error signal was defined as follows:
e(i)=(U(i)−U_{TH})·t_{AVAIL}(i). (1)

A least mean square (LMS) adaptive bandwidth control approach to dynamically update the movable boundary was used. According to the LMS optimization criterion, one wants to minimize (e(i)²). Differentiating this expression, one obtains the following equation:

$$\begin{matrix}\frac{\partial }{\partial {t}_{AVAIL} ( i )} {e ( i )}^{2} = 2 e ( i ) \cdot \frac{\partial e ( i )}{\partial {t}_{AVAIL} ( i )} \\ = 2 ( U ( i ) - {U}_{TH} ) \cdot {t}_{AVAIL} ( i ) \cdot \frac{\partial e ( i )}{\partial {t}_{AVAIL} ( i )} .\end{matrix} \qquad ( 2 )$$

The partial derivative term is difficult to determine in practice, and in other types of adaptive bandwith control algorithms, it is incorporated into a single constant, denoted κ. The value of κ is then appropriately tuned for the situation being considered. Using this result, one can write the standard LMS-based steepest descent update equation as follows:

$$\begin{matrix}{t}_{AVAIL} ( i + 1 ) = {t}_{AVAIL} ( i ) + κ ( U ( i ) - {U}_{TH} ) \cdot {t}_{AVAIL} ( i ) \\ = {t}_{AVAIL} ( i ) [ 1 + κ ( U ( i ) - {U}_{TH} ) ] .\end{matrix} \qquad ( 3 )$$

Assuming that t_{AVAIL}(i) is not permitted to drop below a minimum value t_{MIN}, the update equation may be expressed as follows:
t_{AVAIL}(i+1)=max {min(t_{AVAIL}(i)[1+κ(U(i)−U_{TH})],1),t_{MIN}}. (4)

The choice of κ involves a trade-off between responsiveness and steady state error.

Simulation Results

The simulation parameters are listed in Table 1 below.

TABLE 1
Default Simulation Parameters

| Parameter | Value | |
|---|---|---|
| Superframe interval | 100 | ms |
| WLAN transmission rate | 11 | Mbps |
| Number of mobile stations per AP | 20 | |
| Data packet payload | 200 | bytes |
| Power consumption in LISTEN/RECEIVE mode | 500 | mW |
| Power consumption in TRANSMIT mode | 750 | mW |
| Power consumption in DOZE mode | 2 | mW |
| Min. duration of availability time interval, tₘᵢₙ | 10 | ms |

A simple one-hop access network model with contention-based end station traffic was simulated. Associated with the AP were 20 mobile stations receiving Poisson process packet arrivals. The movable boundary for the start of the unavailability time interval was updated using equation (4) above.

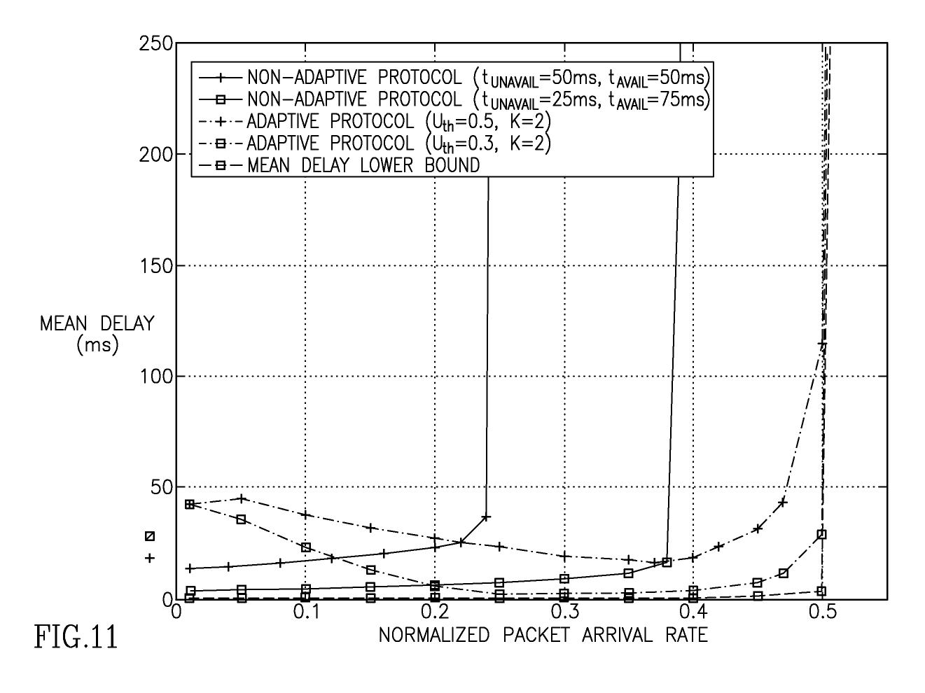

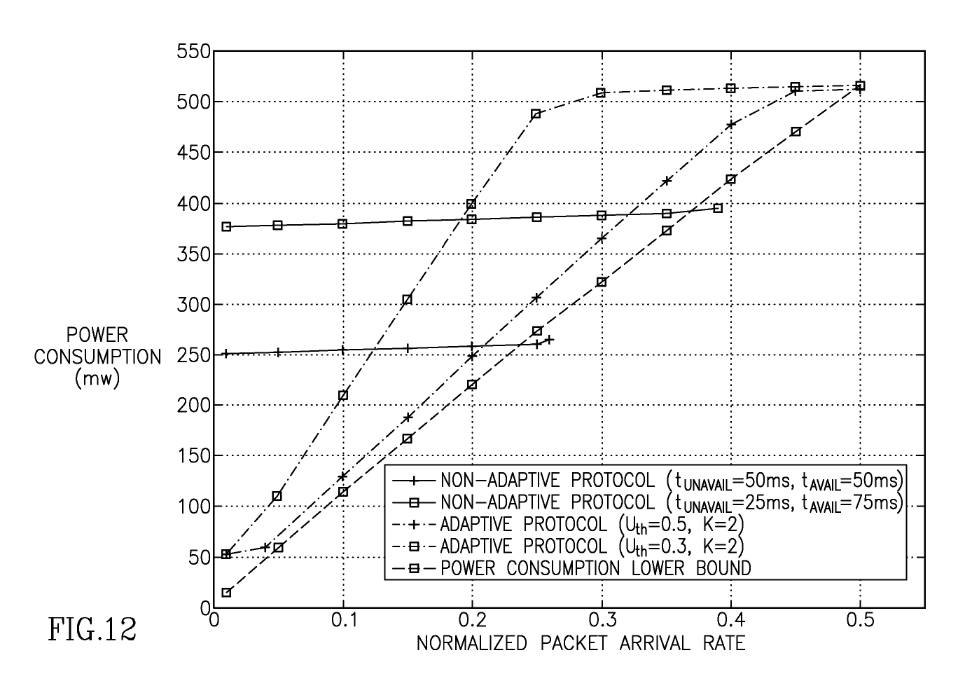

The results shown in FIGS. 11 and 12 hereinbelow were obtained using a discrete event simulator written in the C programming language. This simulator included a detailed implementation of IEEE 802.11 EDCA (CSMA/CA) which is used during the AP contention periods when the mobile stations are active. It was assumed that the small number of AP channel retunings and state transitions per superframe result in overheads which are small compared with the superframe duration.

FIG. 11 shows the mean station packet delay with two different U_{TH} values, 0.3 and 0.5. FIG. 12 shows the AP mean power consumption with two different U_{TH} values, 0.3 and 0.5. FIGS. 11 and 12 also include two curves which would be obtained with fixed indications for the beginnings and ends of the unavailability time intervals. One of the curves represents the case where the AP is unavailable for half of the superframe, so t_{AVAIL}(i)=t_{UNAVAIL}(i)=0.5 The other of the curves represents the case where the AP is unavailable for a quarter of the superframe, so t_{AVAIL}(i)=0.75 and t_{UNAVAIL}(i)=0.25 In these two cases, the traffic-carrying capacity of the system is preset by the fixed indications, and the mean power consumption is relatively constant, varying only due to the fraction of time spent in receive/transmit mode. Compared with the fixed indications cases, the adaptive bandwidth control protocol adapts the duration of the unavailability time interval based on traffic loading. Comparing the 0.3 and 0.5 U_{TH} cases in FIG. 12, the latter case results in significantly better AP power consumption throughout the entire packet arrival rate range. This is due to the fact that larger values of normalized utilization U(i) are needed before the algorithm responds by increasing the offered capacity in a subsequent superframe. In the 0.3 U_{TH} case, the algorithm is much more sensitive to U(i) The corresponding mean delay curves in FIG. 11 show the penalty that is paid in the 0.5 U_{TH} case from a mean delay viewpoint. Having a less reactive AP drives the mean delay up in the 0.5 case compared with 0.3. However, in many cases, this mean delay increase is probably not very significant for best-effort traffic. In any case, the selection of U_{TH} and κ allows the AP to make a trade-off between mean station delay and AP power consumption. It should be noted that the decrease in mean delay as the arrival rate increases is caused by the actions of the adaptive algorithm which increases the responsiveness of the AP as loading increases.

Some additional curves are included in FIGS. 11 and 12. The first additional curve is a mean delay lower bound which is obtained by making the AP always available for packet transmission. In FIG. 11 it can be seen that the 0.3 U_{TH} curve approximates this bound very closely for medium and high loading. The second additional curve is a power consumption lower bound which is obtained by summing up the components required for the successful transmission of packets at a particular packet arrival rate. This bound ignores the overhead due to packet collision.

Although the description hereinabove refers to indications of unavailability time intervals, it is obvious to a person of ordinary skill in the art to modify the embodiments to use instead or additionally, indications of availability time intervals during which an access point is available to receive unsolicited communication from wireless client devices associated therewith.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for time management in a wireless access point, the method comprising:
transmitting a management frame having incorporated therein indications of one or more future unavailability time intervals during which said access point is not available to receive unsolicited communication from wireless client devices that are associated with said access point in a wireless network.

2. The method of claim 1, further comprising:
controlling circuitry in said access point to be in a power-saving state during at least a part of said one or more unavailability time intervals.

3. The method of claim 1, further comprising:
communicating data on behalf of one or more of said wireless client devices during at least a part of said one or more unavailability time intervals.

4. The method of claim 1, wherein said indications are defined with reference to an event of said wireless network.

5. The method of claim 4, wherein said event is a beginning of a contention-free interval.

6. The method of claim 4, wherein said event is an end of transmission of a beacon frame that contains a Delivery Traffic Indication Map.

7. The method of claim 4, wherein said event recurs and one or more of said indications are fixed indications that are applicable with reference to recurrences of said event.

8. The method of claim 4, wherein said event recurs and one or more of said indications are movable indications that are applicable with reference to a single occurrence of said event.

9. The method of claim 8, further comprising:
monitoring usage of traffic-carrying capacity previously offered by said access point to said wireless client devices; and
based at least in part on said usage, setting said movable indications in order to decrease, maintain or increase traffic-carrying capacity offered by said access point to said wireless client devices during a period of time that includes said future unavailability time intervals.

10. The method of claim 1, further comprising:
determining, based at least in part on quality of service requirements of traffic to be supported by said access point, one or more of the number, rate and duration of said one or more unavailability time intervals.

11. The method of claim 1, wherein said indications include one or both of beginning times and end times of said unavailability time intervals.

12. A method for time management in a wireless client device, the method comprising:
receiving a management frame from an access point associated with said client device in a wireless network, said management frame incorporating indications of one or more future unavailability time intervals during which said access point will not be available to receive unsolicited communication from said client device; and
not transmitting unsolicited communication to said access point during said one or more future unavailability time intervals.

13. The method of claim 12, further comprising:
entering a power-saving state during at least a part of said one or more unavailability time intervals.

14. The method of claim 13, wherein said indications are defined with reference to a recurring event of said network, the method further comprising:
exiting said power-saving state for a start of a particular time interval following a recurrence of said event if said client device is certain that said access point will be available to receive unsolicited communication from said client device during said particular time interval; and
otherwise, exiting said power-saving state to receive another management frame having incorporated therein further indications of another one or more unavailability time intervals, wherein at least one of said further indications is defined with reference to a single occurrence of said event.

15. A wireless access point comprising:
a wireless communication interface;
a processor coupled to said wireless communication interface;
memory to store code which, when executed by said processor, results in transmission via said wireless communication interface of a management frame having incorporated therein indications of one or more future unavailability time intervals during which said access point is not available to receive unsolicited communication from wireless client devices that are associated with said access point in a wireless network.

16. The wireless access point of claim 15, wherein said code, when executed by said processor, further results in:
controlling circuitry in said access point to be in a power-saving state during at least a part of said one or more unavailability time intervals.

17. The wireless access point of claim 15, wherein said code, when executed by said processor, further results in:
communicating data on behalf of one or more of said wireless client devices during at least a part of said one or more unavailability time intervals.

18. A wireless device comprising:
a wireless communication interface to receive a management frame from an access point associated with said device, said management frame having incorporated therein indications of one or more future unavailability time intervals during which said access point will not be available to receive unsolicited communication from said device;
a processor coupled to said wireless communication interface;
memory to store code which, when executed by said processor, prevents said wireless device from transmitting unsolicited communication to said access point during said one or more future unavailability time intervals.

19. The wireless device of claim 18, wherein said code, when executed by said processor, further results in:
controlling circuitry in said device to be in a power-saving state during at least a part of said one or more unavailability time intervals.

20. The wireless device of claim 19, wherein said code, when executed by said processor, further results in:
exiting said power-saving state for a start of a particular time interval following a recurrence of said event if said client device is certain that said access point will be available to receive unsolicited communication from said client device during said particular time interval; and
otherwise, exiting said power-saving state to receive via said wireless communication interface another management frame having incorporated therein further indications of another one or more unavailability time intervals, wherein at least one of said further indications is defined with reference to a single occurrence of said event.
